(19) United States
(12) Patent Application Publication
(10) Pub. No.: US 2005/0128667 A1
(43) Pub. Date: Jun. 16, 2005

(54) Power source apparatus supplying multiple output

(75) Inventors: Teruo Okada, Gunma (JP); Ryuya Nakajima, Saitama (JP); Mitsuaki Ooya, Gunma (JP); Shinichi Ishida, Gunma (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: TAIYO YUDEN CO., LTD., Tokyo (JP)

(21) Appl. No.: 10/775,216

(22) Filed: Feb. 11, 2004

(30) Foreign Application Priority Data
Dec. 15, 2003 (JP) 2003-415927

(51) Int. Cl. H02H 3/00

(52) U.S. Cl. 361/64

(57) ABSTRACT

Multiple output power source apparatus enables to optimize efficiency for each output and to perform simultaneous shutdown and synchronous oscillations between the outputs. Power source circuits of various types connected to a power source are provided, and those power source circuits have a function of outputting an abnormality signal to other power source circuits when an abnormality occurs in the own circuit and shutting down the operation of the own circuit by an abnormality signal from other power source circuits and a function of outputting a synchronous oscillation signal synchronized with a switching oscillation frequency used for controlling the own circuit to other power source circuits and conducting synchronous control of the switching frequency used for controlling other power source circuits.

### BACKGROUND OF THE INVENTION

1. Field of the Invention

The present invention relates to a multiple output power source circuit for outputting a plurality of voltages, and more particularly to a multiple output power source circuit in which at least two of a plurality of power source circuits are provided with independent control circuits, thereby increasing decentralization and efficiency of the multiple output power source.

2. Description of the Related Art

The conventional multiple output power source circuits for outputting a plurality of voltages are known to have configurations in which

a plurality of outputs are centralized-controlled with one control circuit (centralized control type); or

a plurality of power control circuits of various types operating independently from each output are provided (decentralized control type).

However, the following drawbacks are associated with the aforementioned configuration 1) of the centralized control type.

Because all the switching frequencies used in the power sources of various types are controlled to the same frequency, an optimum oscillation frequency cannot be set for each output voltage. As a result, the efficiency cannot be optimized.

Because a plurality of output voltages are commonly controlled by a single control circuit, settings can be made only such that all the output voltages are shut down together or none of the output voltages is shut down when an abnormality occurs. As a result, the power source is not suitable for applications for which none of those settings is appropriate. In order to make the power source suitable for such applications, the circuits and components for this purpose have to be added, thereby raising the cost of the entire device.

The switching phase used in the power source circuits of various types is fixed with respect to each output voltage. As a result, optimum phase setting corresponding to each output voltage cannot be made.

Because a plurality of switching circuits corresponding to each output voltage are controlled with one control circuit, the length of wiring leading from this one control circuit to a plurality of switching circuits corresponding to each output voltage becomes long. As a result, the effect of external noise on the wiring causes unstable operation and malfunction. Moreover, the noise produced by the wiring affects the external circuits.

The following drawbacks are associated with the aforementioned configuration 2) of decentralized control type.

Because power source circuits corresponding to each output voltage operate independently from each other, this configuration cannot cope with the situation of shutting down all the output voltages together, and the circuits and components to cope with this situation have to be added to resolve this problem, thereby raising the cost of the entire device.

Because power source circuits corresponding to each output voltage operate independently from each other, synchronous oscillations cannot be conducted between specific output voltages. As a result, beat noise is generated.

Furthermore, Japanese Patent Application Publication No. 08-256471 disclosed a power source device in which a multiple output power source is composed by connecting a plurality of DC-DC converters, and the technique described in this patent application publication realized coupled start and shut down of each DC-DC converter by using a common relay circuit.

However, with the technique described in Japanese Patent Application Publication No. 08-256471, it was necessary to provide a complex relay circuit outside the DC-DC converter, which made it inappropriate from the standpoint of miniaturizing the device.

### SUMMARY OF THE INVENTION

Accordingly, it is an object of the present invention to provide a multiple output power source apparatus which can be miniaturized in size and in which efficiency can be optimized for each output voltage and simultaneous shutdown and synchronous oscillations are possible between any output voltages.

In order to attain this object, the present invention provides a multiple output power source apparatus comprising a plurality of power source circuits equipped with independent output control circuits, wherein each of the power source circuits equipped with the independent output control circuits comprises abnormality signal output means for conducting operation shutdown of the own circuit when an abnormality occurs in the own circuit and for outputting an abnormality signal to other power source circuits.

With the present invention, because a multiple output power source apparatus is constructed by employing a combination of at least two power source circuits having independent control circuits, the efficiency can be optimized for each output voltage and simultaneous shutdown and synchronous oscillations are possible between any output voltages.

### BRIEF DESCRIPTION OF THE DRAWINGS

FIG. 1 is a block diagram illustrating an embodiment of the multiple output power source apparatus in accordance with the present invention;

FIG. 2 is a block diagram illustrating a detailed configuration of a voltage-up-down control circuit provided in a power source circuit 30-1 shown in FIG. 1;

FIG. 3 is a circuit diagram illustrating an example of a converter circuit provided in each power source circuit shown in FIG. 1;

FIG. 4 is a block diagram illustrating another embodiment of the multiple output power source apparatus in accordance with the present invention;

FIG. 5 is a block diagram illustrating a detailed configuration of a voltage-up-down control circuit provided in a power source circuit 30-1 shown in FIG. 4;

FIG. 6 is a block diagram illustrating another configuration example of a voltage-up-down control circuit provided in a power source circuit 30-1 shown in FIG. 4;

FIG. 7 is a block diagram illustrating another configuration example of a voltage-up control circuit provided in a power source circuit 30-2 shown in FIG. 4;

FIG. 8 is a block diagram illustrating another configuration example of a voltage-down control circuit provided in a power source circuit 30-4 shown in FIG. 4;

FIG. 9 is a block diagram illustrating a configuration example of a synchronous line monitor 350 shown in FIG. 6, FIG. 7, and FIG. 8;

FIG. 10 is a timing chart illustrating the operation of the synchronous line monitor 350 shown in FIG. 9;

FIG. 11 is a block diagram illustrating another configuration example of a synchronous line monitor 350 shown in FIG. 6, FIG. 7, and FIG. 8; and

FIG. 12 is a timing chart illustrating the operation of the synchronous line monitor 350 shown in FIG. 11.

### DESCRIPTION OF THE PREFERRED EMBODIMENTS

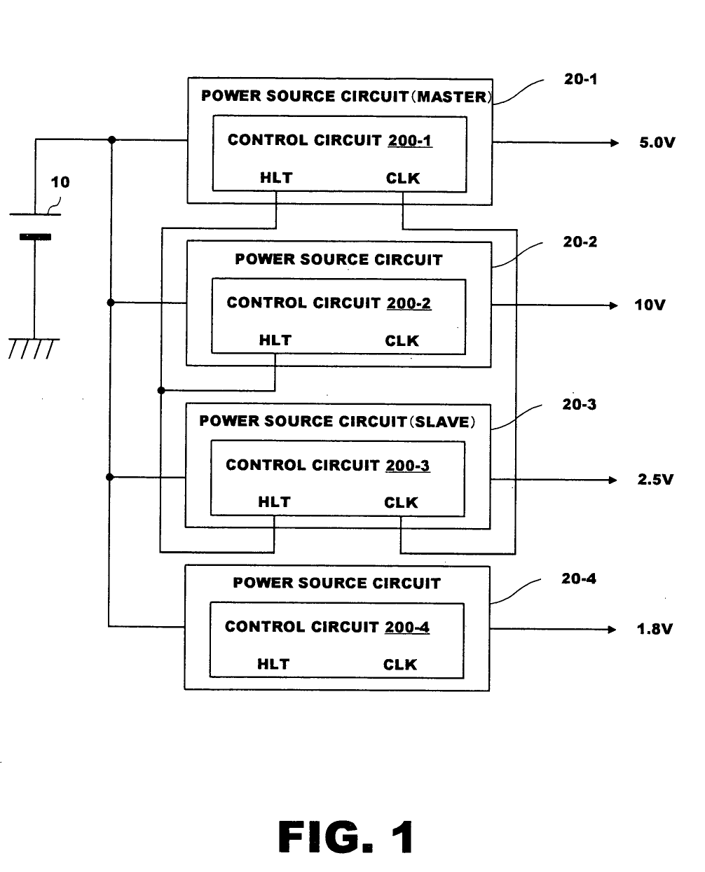

Embodiment of the multiple output power source apparatus in accordance with the present invention will be described hereinbelow with reference to the appended drawings. FIG. 1 is a block diagram illustrating an embodiment of the multiple output power source apparatus in accordance with the present invention.

The multiple output power source apparatus shown in FIG. 1 is composed, for example, by connecting a voltage-up-down power source circuit (master) 20-1, a voltage-up power source circuit 20-2, a voltage-down power source circuit (slave) 20-3, and a voltage-down power source circuit 20-4 in parallel to a power source 10 generating a voltage of 3.0 V to 5.5 V. In this device, a voltage of 5.0 V is outputted from the voltage-up-down power source circuit 20-1, a voltage of 10 V is outputted from the voltage-up power source circuit 20-2, a power source voltage of 2.5 V is outputted from the voltage-down power source circuit 20-3, and a voltage of 1.8 V is outputted from the voltage-down power source circuit 20-4.

Here, the voltage-up-down power source circuit 20-1, voltage-up power source circuit 20-2, voltage-down power source circuit 20-3, and voltage-down power source circuit 20-4 are provided with a voltage-up-down control circuit 200-1, a voltage-up control circuit 200-2, a voltage-down control circuit 200-3, and a voltage-down control circuit 200-4, respectively, those control circuits being composed of integrated circuits. Those voltage-up-down control circuit 200-1, voltage-up control circuit 200-2, voltage-down control circuit 200-3, and voltage-down control circuit 200-4 control switching of converter circuits (not shown in the figure) located inside the voltage-up-down power source circuit 20-1, voltage-up power source circuit 20-2, voltage-down power source circuit 20-3, and voltage-down power source circuit 20-4 and generate a voltage of 5.0 V, 10V, 2.5 V, and 1.8 V, respectively.

The voltage-up-down control circuit 200-1 is provided with a fault terminal HLT (“HLT” is an abbreviation of “Halt” or “Fault”. Same hereinbelow) for outputting an abnormality signal when an abnormality occurs in the own circuit and inputting an abnormality signal from another circuit and shutting down the own power source circuit and a synchronous oscillation output terminal CLK for outputting a synchronous oscillation signal for synchronizing the switching of the aforementioned converter circuits to another power source circuit. Further, the voltage-up control circuit 200-2, voltage-down control circuit 200-3, and voltage-down control circuit 200-4 are provided with respective fault terminals HLT for outputting an abnormality signal when an abnormality occurs in the own circuit and inputting an abnormality signal from another circuit and shutting down the own power source circuit and a synchronous oscillation input terminal CLK for inputting the synchronous oscillation signal outputted from the synchronous oscillation output terminal of the voltage-up-down control circuit 200-1 and synchronizing the switching of the aforementioned converter circuit in the own device.

Here, the fault terminal HLT can be used as an input/output terminal not only for the abnormality signal informing that an abnormality has occurred in any circuit, but also as a forced shutdown signal which is outputted when a circuit is wished to be shut down forcibly.

Further, the multiple output power source apparatus of this embodiment is constructed so that the fault terminal of the voltage-up-down control circuit 200-1 of the voltage-up-down power source circuit 20-1, the fault terminal of the voltage-up control circuit 200-2 of the voltage-up power source circuit 20-2, and the fault terminal of the voltage-down control circuit 200-3 of the voltage-down power source circuit 20-3 are connected to each other. If an abnormality is detected in one of those voltage-up-down control circuit 200-1, voltage-up control circuit 200-2, and voltage-down control circuit 200-3, other power source circuits are shut down.

In the above-described configuration, the fault terminal of the voltage-down control circuit 200-4 of the voltage-down power source circuit 20-4 shown in FIG. 1 is not connected to the fault terminal of other power source circuits. Therefore, the voltage-down power source circuit 20-4 is not shut down even if an abnormality is detected in other power source circuits.

Further, the synchronous oscillation output terminal of the voltage-up-down control circuit 200-1 of the voltage-up-down power source circuit 20-1 is connected to the synchronous oscillation input terminal of the voltage-down control circuit 200-3 of the voltage-down power source circuit 20-3, and switching of the converter of the voltage-down power source circuit 20-3 is synchronized with switching of the converter of the voltage-up-down power source circuit 20-1. As a result, a master-slave relationship is established between the voltage-up-down power source circuit 20-1 and the voltage-down power source circuit 20-3.

Furthermore, in the above-described configuration the synchronous oscillation input terminal of the voltage-up control circuit 200-2 of the voltage-up power source circuit 20-2 and the synchronous oscillation input terminal of the voltage-down control circuit 200-4 of the voltage-down power source circuit 20-4 are not connected to the synchronous oscillation output terminal of the voltage-up-down control circuit 200-1 of the voltage-up-down power source circuit 20-1. Therefore, the voltage-up power source circuit 20-2 and the voltage-down power source circuit 20-4 operate independently, without synchronization with switching of the converter of the voltage-down power source circuit 20-1.

Any connection can be realized between the fault terminals of power source circuits and with the synchronous oscillation output terminal, and the power source circuits that are commonly shut down by this connection mode and the power source circuits that have a master-slaver relationship with respect to converter switching can be set according to the utilization mode desired by the user.

Further, in the configuration shown in FIG. 1, the voltage-up-down power source circuit 20-1, voltage-up power source circuit 20-2, voltage-down power source circuit 20-3, and voltage-down power source circuit 20-4 were connected in parallel with the power source 10, but some of the power source circuits may be connected in serial.

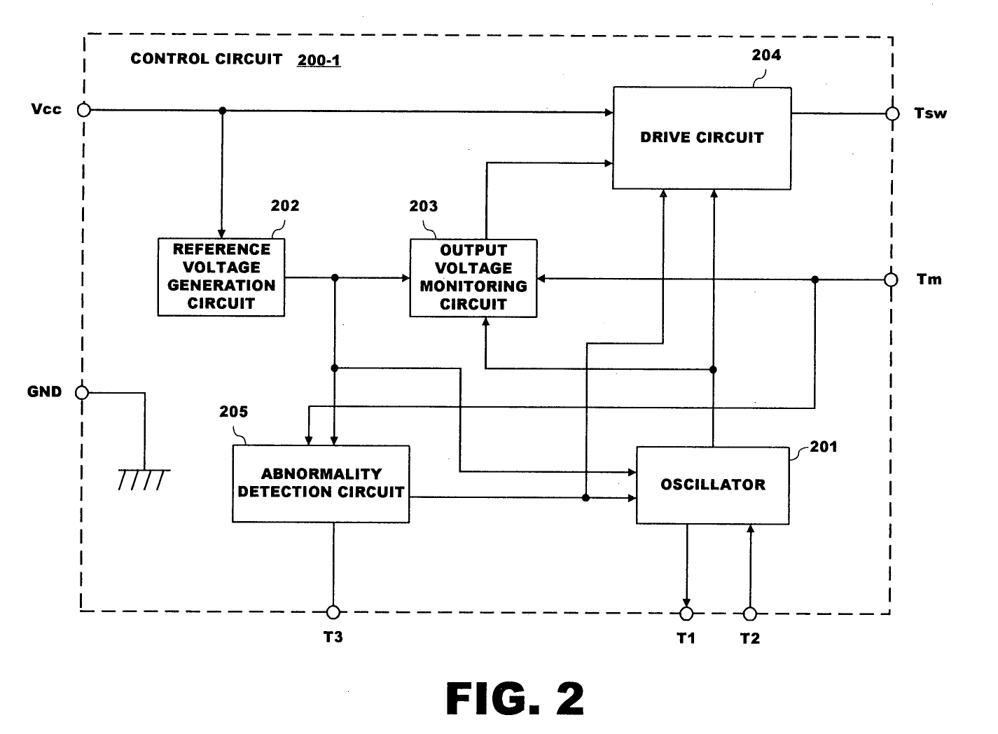

FIG. 2 is a block diagram showing as a voltage-up-down control circuit 200 the detailed configuration of the voltage-up-down control circuit 200-1 provided in the voltage-up-down power source circuit 20-1 shown in FIG. 1.

Referring to FIG. 2, a terminal of the voltage-up-down control circuit 200 corresponds to the synchronous oscillation output terminal of the voltage-up-down control circuit 200-1 shown in FIG. 1, and a terminal T3 corresponds to the fault terminal of the voltage-up-down control circuit 200-1 shown in FIG. 1.

The voltage-up control circuit 200-2, voltage-down control circuit 200-3, and voltage-down control circuit 200-4 shown in FIG. 1 also can be composed same as the voltage-up-down control circuit 200 shown in FIG. 2. In this case, the synchronous oscillation input terminals of the voltage-up control circuit 200-2, voltage-down control circuit 200-3, and voltage-down control circuit 200-4 shown in FIG. 1 will correspond to the terminal T2 of the voltage-up-down control circuit 200 shown in FIG. 2.

The voltage-up-down control circuit 200 shown in FIG. 2 is composed of an oscillator 201, a reference voltage generation circuit 202, an output voltage monitoring circuit 203, a drive circuit 204, and an output voltage abnormality detection circuit 205.

Basic operation of the voltage-up-down control circuit 200 involves controlling the drive circuit 204 according to the oscillation signal generated by the oscillator 201, and outputting a switching signal for controlling the switching of the converter in the power source circuit where the voltage-up-down control circuit 200 is provided from a terminal Tsw.

A power source voltage Vcc for controlling the voltage-up-down control circuit 200 is applied to a terminal Vcc, and this power source voltage Vcc is applied to the reference voltage generation circuit 202 and to the drive circuit 204.

The reference voltage generation circuit 202 generates a reference voltage for causing the operation of the voltage-up-down control circuit 200, and the reference voltage generated from the reference voltage generation circuit 202 is applied to the oscillator 201, output voltage monitoring circuit 203, and output voltage abnormality detection circuit 205.

The output voltage monitoring circuit 203 monitors the output voltage of the power source circuit where the voltage-up-down control circuit 200 is provided, this voltage being inputted from a terminal Tm, and controls the drive circuit 204 so that this output voltage thereof is stably outputted at a desired level.

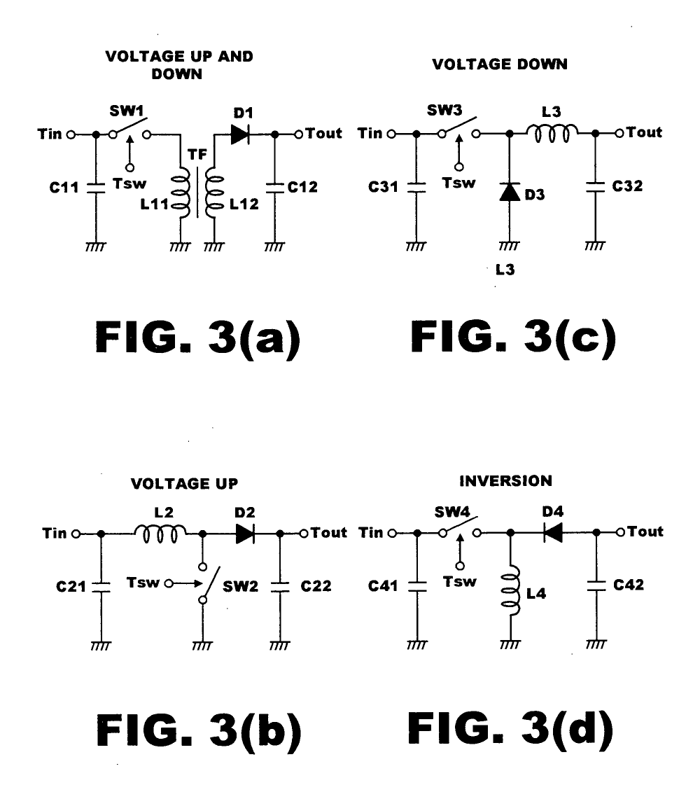

The drive circuit 204 forms a switching signal for a converter located in the power source circuit provided with this voltage-up-down control circuit 200 based on the oscillation signal outputted from the oscillator 201 and the output of the output voltage monitoring circuit 203. The converter circuit will be described below in greater detail with reference to FIG. 3.

The output voltage abnormality detection circuit 205 detects the abnormality of the power source circuit where the voltage-up-down control circuit 200 is provided based on the output voltage of this power source circuit which is inputted from the terminal Tm. Furthermore, the output voltage abnormality detection circuit 205 detects abnormalities in other power source circuits based on the abnormality signals inputted from the terminal T3. When those abnormalities are detected, the abnormality signal is outputted from the terminal T3 and posted to other power source circuits, this abnormality signal is also outputted to the oscillator 201, oscillation of the oscillator 201 is stopped, and the voltage-up-down power source circuit 20-1 is shut down.

The operation of the voltage-up control circuit 200-2, voltage-down control circuit 200-3, and voltage-down control circuit 200-4 provided in other power source circuits shown in FIG. 1 is basically identical to the operation of the voltage-up-down control circuit 200-1 shown in FIG. 2.

FIG. 3 is a circuit diagram illustrating an example of a converter circuit provided in power source circuits shown in FIG. 1.

Referring to FIG. 3, the circuit shown in FIG. 3(a) illustrates an example of a converter circuit in which the voltage can be stepped up and down and is provided, for example, in the voltage-up-down power source circuit 20-1 shown in FIG. 1. The converter circuit is composed of a capacitor C11 connected to an input terminal Tin, a switch element SW1 which is switched by a switching signal outputted from a terminal Tsw of the voltage-up-down control circuit 200 shown in FIG. 2, a transformer TF having a coil L11 and a coil L12, a diode D1, and a capacitor C12 connected to an output terminal Tout.

In the circuit shown in FIG. 3(a), a DC voltage of, for example, 3.0-5.5 V from the power source 10 shown in FIG. 1 is inputted in the input terminal Tin, and the DC voltage of 5.0 V that was converted down by switching of the switch element SW1 is outputted from the output terminal Tout.

Further, FIG. 3(b) illustrates an example of a converter circuit in which the voltage can be stepped up, this circuit being provided, for example, in the voltage-up power source circuit 20-2 shown in FIG. 1. This converter circuit is composed of a capacitor C21 and a coil L2 connected to the input terminal Tin, a switch element SW2 which is switched by a switching signal outputted from a terminal corresponding to the terminal Tsw of the voltage-up control circuit 200-2 similar to the voltage-up-down control circuit 200 shown in FIG. 2, a diode D2, and a capacitor C22 connected to the output terminal Tout.

In the circuit shown in FIG. 3(b), a DC voltage of, for example, 3.0-5.5 V from the power source 10 shown in FIG. 1 is inputted in the input terminal Tin, and the DC voltage of 10 V that was converted up by switching of the switch element SW2 is outputted from the output terminal Tout.

Further, FIG. 3(c) illustrates an example of a converter circuit in which the voltage can be stepped down, this circuit being provided, for example, in the voltage-down power source circuit 20-3 and the voltage-down power source circuit 20-4 shown in FIG. 1. This converter circuit is composed of a capacitor C31 connected to the input terminal Tin, a switch element SW3 which is switched by a switching signal outputted from a terminal corresponding to the terminal Tsw of the voltage-down control circuit 200-3 or voltage-down control circuit 200-4 similar to the voltage-up-down control circuit 200 shown in FIG. 2, a diode D3, a coil L3, and a capacitor C32 connected to the output terminal Tout.

In the circuit shown in FIG. 3(c), a DC voltage of, for example, 3.0-5.5 V from the power source 10 shown in FIG. 1 is inputted in the input terminal Tin, and the DC voltage of 2.5 or 1.8 V that was converted down by switching of the switch element SW3 is outputted from the output terminal Tout.

Further, FIG. 3(d) illustrates an example of a converter circuit that can output a negative voltage. This converter circuit is composed of a capacitor C41 connected to the input terminal Tin, a switch element SW4 which is switched by a switching signal outputted from a terminal corresponding to the terminal Tsw of control circuit similar to the voltage-up-down control circuit 200 shown in FIG. 2, a coil L4, a diode D4, and a capacitor C42 connected to the output terminal Tout.

In the circuit shown in FIG. 3(d), a DC voltage of, for example, 3.0-5.5 V from the power source 10 shown in FIG. 1 is inputted in the input terminal Tin, and a negative DC voltage is outputted from the output terminal Tout by switching of the switch element SW4. The circuit shown in FIG. 3(d) can be used when a negative DC voltage is required.

In the circuits shown in FIG. 3(a)-(d), switch elements SW1 to SW4 can be composed, for example, by using field-effect transistors (FET).

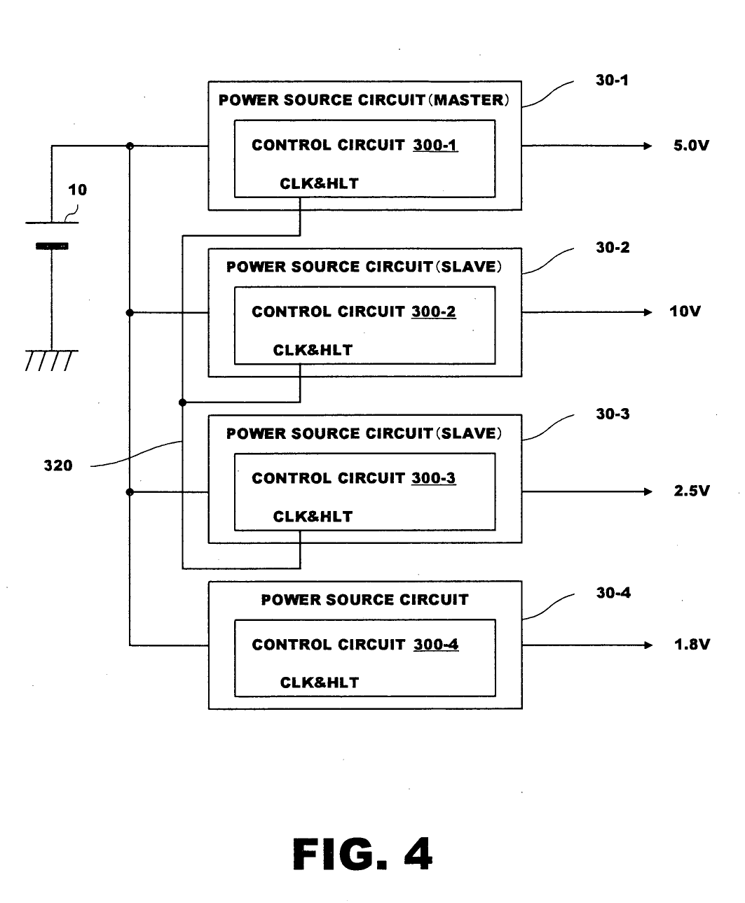

FIG. 4 is a block diagram illustrating another embodiment of the multiple output power source apparatus in accordance with the present invention.

The multiple output power source apparatus of this embodiment is composed of a fault terminal for inputting and outputting abnormality signals described in the embodiment illustrated by FIG. 1, a synchronous oscillation output terminal for outputting and inputting a synchronous oscillating signal, and a terminal common with the synchronous oscillation input terminal. Other basic constituent features and operation of this device are identical to those of the device shown in FIG. 1. Further, in FIG. 4, components demonstrating functions identical to those of the multiple output power source apparatus shown in FIG. 1 are assigned with identical symbols to facilitate explanation.

Thus, the multiple output power source apparatus shown in FIG. 4 is composed, similarly to the multiple output power source apparatus shown in FIG. 1, for example, by connecting a voltage-up-down power source circuit (master) 30-1, a voltage-up power source circuit 30-2 (slave), a voltage-down power source circuit (slave) 30-3, and a voltage-down power source circuit 20-4 in parallel to a power source 10 generating a voltage of 3.0V to 5.5 V. In this device, a voltage of 5.0 V is outputted from the voltage-up-down power source circuit 30-1, a voltage of 10 V is outputted from the voltage-up power source circuit 30-2, a power source voltage of 2.5 V is outputted from the voltage-down power source circuit 30-3, and a voltage of 1.8 V is outputted from the voltage-down power source circuit 30-4.

Here, the voltage-up-down power source circuit 30-1, voltage-up power source circuit 30-2, voltage-down power source circuit 30-3, and voltage-down power source circuit 30-4 are provided with a voltage-up-down control circuit 300-1, a voltage-up control circuit 300-2, a voltage-down control circuit 300-3, and a voltage-down control circuit 300-4, respectively, those control circuits being composed of integrated circuits. Those voltage-up-down control circuit 300-1, voltage-up control circuit 300-2, voltage-down control circuit 300-3, and voltage-down control circuit 300-4 control switching of converter circuits located inside the voltage-up-down power source circuit 30-1, voltage-up power source circuit 30-2, voltage-down power source circuit 30-3, and voltage-down power source circuit 30-4 and generate a voltage of 5.0 V, 10 V, 2.5 V, and 1.8 V, respectively. Converter circuits identical to those explained with reference to FIG. 3 can be used as the converter circuits provided in the voltage-up-down power source circuit 30-1, voltage-up power source circuit 30-2, voltage-down power source circuit 30-3, and voltage-down power source circuit 30-4.

In the multiple output power source apparatus of this embodiment, the voltage-up-down control circuit 300-1 is provided with a synchronous oscillation output and fault terminal CLK&HLT for outputting a synchronous oscillation signal for synchronizing the switching of the aforementioned converter circuits to another power source circuit, outputting an abnormality signal when an abnormality occurs in the own circuit, and inputting an abnormality signal from another circuit and shutting down the own power source circuit. Further, the voltage-up control circuit 300-2, voltage-down control circuit 300-3, and voltage-down control circuit 300-4 are provided with respective synchronous oscillation input and fault terminals CLK&HLT for inputting the abnormality signal and synchronous oscillation signal outputted from the synchronous oscillation output and fault terminal CLK&HLT of the voltage-up-down control circuit 300-1 and outputting an abnormality signal when an abnormality occurs in the own circuit. The “HLT” used herein comprises both the Halt and the Fault.

Further, in the multiple output power source apparatus of this embodiment, the synchronous oscillation output and fault terminal of the voltage-up-down control circuit 300-1 of the voltage-up-down power source circuit 30-1 and the synchronous oscillation output and fault terminals of the voltage-up control circuit 300-2 of the voltage-up power source circuit 30-2 and the voltage-down control circuit 300-3 of the voltage-down power source circuit 30-3 are connected to each other.

With such a configuration, if an abnormality is detected in one of the voltage-up-down control circuit 200-1, voltage-up control circuit 200-2, and voltage-down control circuit 200-3, control is conducted so as to shut down other power source circuits. Further, a master-slave relationship is established between the voltage-up-down power source circuit 30-1 and the voltage-up power source circuit 30-2, voltage-down power source circuit 30-3, and switching of the converter of the voltage-up power source circuit 30-2 and voltage-down power source circuit 30-3 is synchronized with switching of the converter of the voltage-up-down power source circuit 30-1.

Further, in the above-described configuration, the synchronous oscillation output and fault terminal of the voltage-down control circuit 300-4 of the voltage-down power source circuit 30-4 is not connected to other power source circuits. Therefore, the voltage-down power source circuit 30-4 is not shut down even if an abnormality is detected in other power source circuits. Moreover, the voltage-down power source circuit 30-4 operates independently without synchronization with switching of the converter of the voltage-up-down power source circuit 30-1.

Any connection can be realized between the synchronous oscillation output and fault terminal of the voltage-up-down control circuit 300-1 of the voltage-up-down power source circuit 30-1 and the synchronous oscillation output and fault terminals of other power source circuits, and the power source circuits that are commonly shut down by this connection mode and the power source circuits that have a master-slaver relationship with respect to converter switching can be set according to the utilization mode desired by the user.

Further, in the configuration shown in FIG. 4, similarly to the configuration shown in FIG. 1, the voltage-up-down power source circuit 30-1, voltage-down power source circuit 30-3, voltage-down power source circuit 30-3, and voltage-down power source circuit 30-4 were connected in parallel with the power source 10, but some of the power source circuits may be connected in serial.

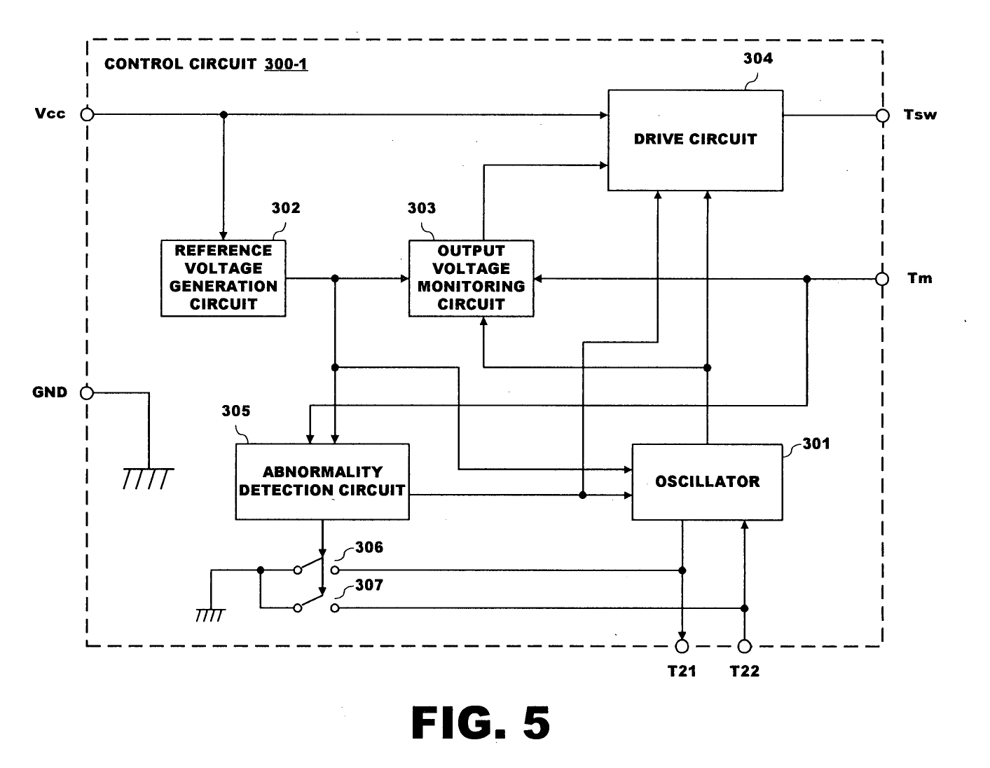

FIG. 5 is a block diagram showing as a voltage-up-down control circuit 300 the detailed configuration of the voltage-up-down control circuit 300-1 provided in the voltage-up-down power source circuit 30-1 shown in FIG. 4.

Referring to FIG. 5, terminals T21 and T22 correspond to the synchronous oscillation output and fault terminal CLK&HLT of the voltage-up-down control circuit 300-1 shown in FIG. 4.

The voltage-up control circuit 300-2, voltage-down control circuit 300-3, and voltage-down control circuit 300-4 shown in FIG. 4 also can be composed same as the voltage-up-down control circuit 300 shown in FIG. 5. In this case, the synchronous oscillation input and fault terminals of the voltage-up control circuit 300-2, voltage-down control circuit 300-3, and voltage-down control circuit 300-4 shown in FIG. 4 will correspond to the terminal T22 of the circuit shown in FIG. 5.

The voltage-up-down control circuit 300 shown in FIG. 5 has a basic configuration identical to that of the voltage-up-down control circuit 200 shown in FIG. 2, the difference therebetween being in that the fault terminal shown by he terminal T3 in FIG. is commonly used as the synchronous oscillation output terminal T1 and the synchronous oscillation input terminal T2.

Thus, the voltage-up-down control circuit 300 shown in FIG. 5 is composed of an oscillator 301, a reference voltage generation circuit 302, an output voltage monitoring circuit 303, a drive circuit 304, an output voltage abnormality detection circuit 305, and abnormality signal output switches 306 and 307.

Here, the voltage-up-down control circuit 300 controls the drive circuit 304 according to the oscillation signal generated by the oscillator 301 and outputs a switching signal for controlling the switching of the converter in the power source circuit where the voltage-up-down control circuit 300 is provided from a terminal Tsw.

A power source voltage Vcc for controlling the voltage-up-down control circuit 300 is applied to a terminal Vcc, and this power source voltage Vcc is applied to the reference voltage generation circuit 302 and to the drive circuit 304.

The reference voltage generation circuit 302 generates a reference voltage for causing the operation of the voltage-up-down control circuit 300, and the reference voltage generated from the reference voltage generation circuit 302 is applied to the 301, output voltage monitoring circuit 303, and output voltage abnormality detection circuit 305.

The output voltage monitoring circuit 303 monitors the output voltage of the power source circuit where this voltage-up-down control circuit 300 is provided, this voltage being inputted from a terminal Tm, and controls the drive circuit 204 so that this output voltage thereof is stably outputted at a desired level.

The drive circuit 304 forms a switching signal for a converter located in the power source circuit provided with this voltage-up-down control circuit 300 based on the oscillation signal outputted from the 301 and the output of the output voltage monitoring circuit 303. A circuit similar to that shown in FIG. 3 can be used as the converter circuit.

The output voltage abnormality detection circuit 305 detects an abnormality of the power source circuit where the voltage-up-down control circuit 300 is provided based on the output voltage of this power source circuit which is inputted from the terminal Tm, and when the abnormality is detected, switches on the abnormality signal output switches 306 and 307: As a result, both the terminal T21 and the terminal T22 become at a ground level.

Therefore, in the voltage-up control circuit 300-2, voltage-down control circuit 300-3, and voltage-down control circuit 300-4 shown in FIG. 4, the voltage levels of the synchronous oscillation input and fault terminals become the ground level, thereby making it possible to detect the abnormality of the voltage-up-down power source circuit 30-1 with the voltage-up control circuit 300-2, voltage-down control circuit 300-3, and voltage-down control circuit 300-4.

More specifically, if the voltage level of the synchronous oscillation input and fault terminal becomes the ground level, the terminal T22 shown in FIG. 5 becomes at a ground level and, therefore, oscillation of the oscillator 301 is stopped and the voltage-up power source circuit 30-2 and the voltage-down power source circuit 30-3 are shut down.

Similarly, when the voltage level of any of synchronous oscillation input and fault terminals of the voltage-up control circuit 300-2, voltage-down control circuit 300-3, and voltage-down control circuit 300-4 in the voltage-up-down power source circuit 30-1 shown in FIG. 4 becomes the ground level, the terminal T21 shown in FIG. 5 becomes at a ground level and, therefore, oscillation of the oscillator 301 is stopped and the voltage-up-down power source circuit 30-1 is shut down.

FIG. 6 is a block diagram illustrating another configuration example of the voltage-up-down control circuit provided in the voltage-up-down power source circuit shown in FIG. 4. The voltage-up-down power source circuit 30-1 shown in FIG. 6 is composed of a power transformation block comprising elements denoted by symbols C11, SW1, L11, TF, L12, D1, and C12, and the control circuit 300-1 for controlling this power transformation block. The power transformation block is composed of the circuits identical to those shown in FIG. 3(a).

The voltage-up-down power source circuit 30-1 is provided with an input terminal Tin for connection to the power source 10 shown in FIG. 4, an output terminal Tout for connection to a load which is not shown in the figure, and a synchronization and fault terminal CLK&HLT for connection to a synchronous line 320 shown in FIG. 4. In accordance with the present invention, there may be one or more slaves connected to the master.

The control circuit 300-1 shown in FIG. 6 comprises a synchronous line monitor 350 for detecting the state of the synchronous line 320 shown in FIG. 4 and a power source monitor 352 for detecting an abnormality of the power transformation block, and controls mode switching switches 360, 362, 364 via an OR element 354. The control circuit 300-1 is preferably composed of IC, and connection with the power transformation block is carried out via the drive circuit 304 and power source monitor 352. Here, the drive circuit 304, as explained in the above-described embodiment, controls switching operation of the power transformation block by using the output of the oscillator 301 and generates the desired regulation voltage.

The synchronous line monitor 350 detects the synchronous signal outputted from the synchronous line 320 shown in FIG. 4 and controls the switching frequency of the own circuit and also detects an abnormality signal and control the shut down of the own circuit operation.

The power source monitor 352 detects the output voltage and output current of the power transformation block and evaluates changes in the regulation voltage or an overcurrent state. The operation of the own circuit is shut down when an abnormality is decided to be present in the power transformation block or a load (not shown in the figure) based on the results of this evaluation.

The output of the synchronous line monitor 350 and the output of the power source monitor 352 are connected to the OR element 354, and the output of the OR element 354 is connected to the mode switching switches 360, 362, 364. If an abnormality is detected in any of the synchronous line monitor 350 and power source monitor 352 with such a configuration, the modes of the mode switching switches 360, 362, 364 are switched.

Here, in a normal state, the mode switching switches are connected to a contact point shown by “0” in the figure, and in an abnormal state, they are connected to a contact point shown by “1” in the figure. Thus, in a normal mode of the power source circuit (master) 30-1, the switch 360 is open and the switch 362 connects the 301 to the synchronous line 320, thereby outputting a clock signal generated by the oscillator 301 of the power source circuit (master) 30-1 to the synchronous line 320. Furthermore, the power transformation block is connected to a load (not shown in the figure) with the switch 364.

On the other hand, in an abnormal mode of the power source circuit (master) 30-1, the switch 360 connects the synchronous line 320 to GND and the switch 362 cuts off the oscillator 301 from the synchronous line 320 and the drive circuit 304, thereby shutting down the operation of the own circuit and stopping the output of the clock signal to the power source circuit serving as a slave. At the same time, the switch 364 disconnects the power transformation block and the load (not shown in the figures) and stops power supply to the load.

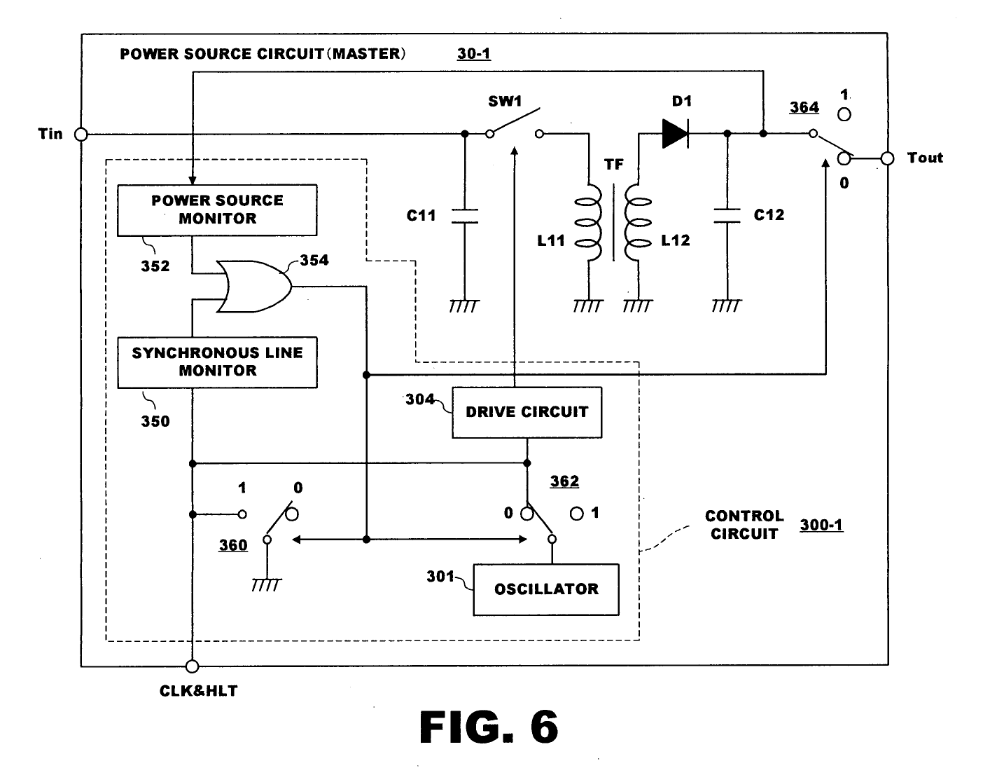

FIG. 7 is a block diagram illustrating another configuration example of the voltage-up control circuit provided in the power source circuit shown in FIG. 4. The voltage-up power source circuit 30-2 shown in the figure is composed of a power transformation block comprising elements denoted by symbols C21, L2, SW2, D2, and C22, and the control circuit 300-2 for controlling this power transformation block. The power transformation block is composed of the circuits identical to those shown in FIG. 3(b).

The voltage-up power source circuit 30-2 is provided with an input terminal Tin for connection to the power source 10 shown in FIG. 4, an output terminal Tout for connection to a load which is not shown in the figure, and a synchronization and fault terminal CLK&HLT for connection to a synchronous line 320 shown in FIG. 4.

The control circuit 300-2 shown in FIG. 7 has a configuration similar to that of the control circuit 300-1 shown in FIG. 6, except for setting of the mode switching switch 362. Thus, with this configuration, in the power source circuit (slave) 30-2, the mode switching switch 362 is fixed to a terminal “1” side. As a result, the oscillator 301 is cut off from the synchronous line 320 and the drive circuit 304, regardless of whether the state is normal or abnormal, and the clock signal generated by the power source circuit (master) 30-1 is incorporated in the own circuit. With such a configuration, switching control of the power source circuit (slave) 30-2 is carried out in the form synchronized with the switching frequency of the power source circuit (master) 30-1.

Here, control with mode switching switches 360, 364 is conducted similarly to the power source circuit (master) 30-1, and when an abnormality appears in the own circuit, the synchronous line 320 is connected to GND with the switch 360, the abnormality information of the own circuit is posted to other power source circuits, the power transformation block and the load (not shown in the figure) are cut off and power supply to the load is stopped by the switch 364.

The power source circuit (slave) 30-3 shown in FIG. 4 has a configuration similar to that of the power source circuit (slave) 30-2, except for the power transformation block, this configuration allowing for the synchronization with the power source circuit (master) 30-1 and for the detection of abnormalities in the power source circuits 30-1, voltage-up power source circuit 30-2, and voltage-down power source circuit 30-3 connected to the synchronous line 320.

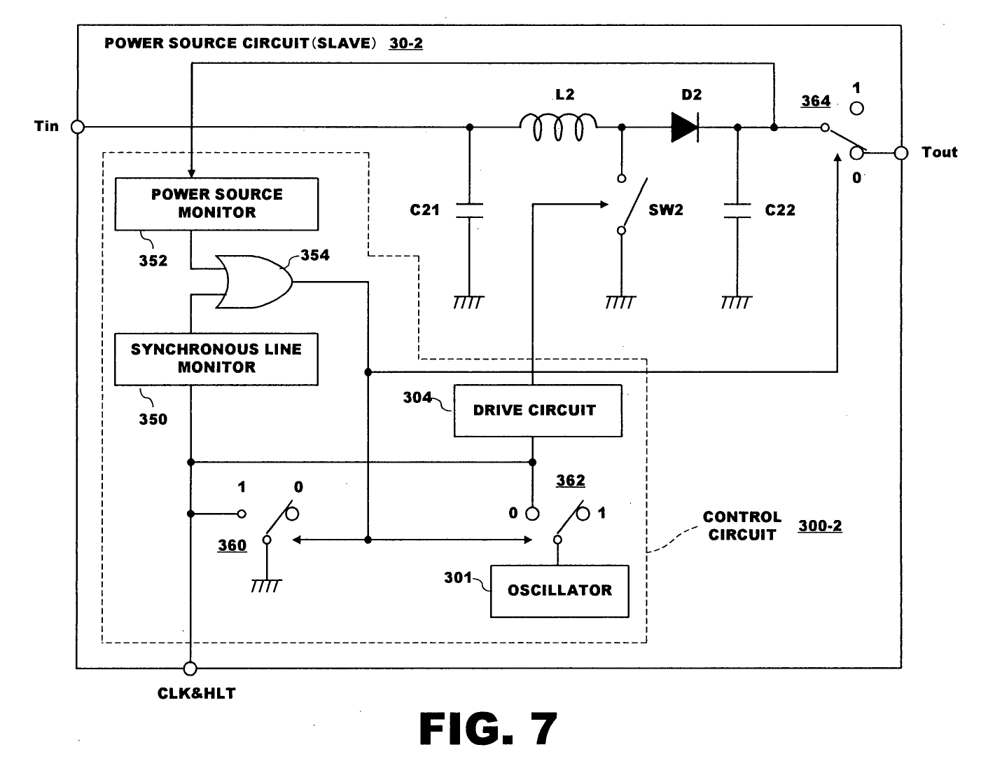

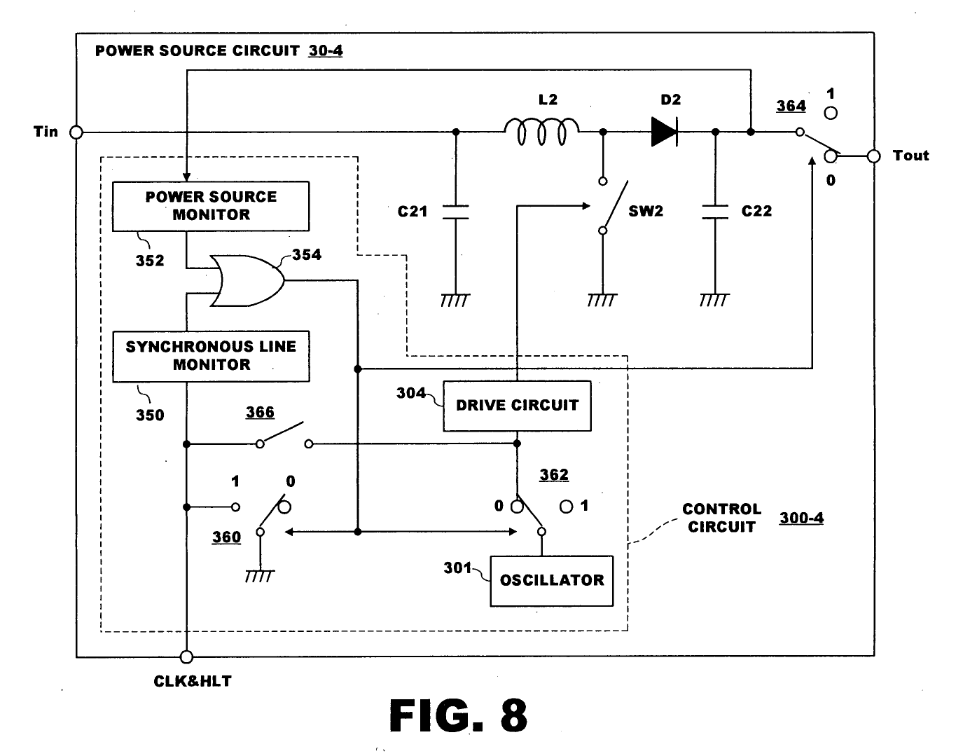

FIG. 8 is a block diagram illustrating another configuration example of the voltage-down control circuit provided in the voltage-down power source circuit shown in FIG. 4. The voltage-down power source circuit 30-4 shown in the figure has a configuration similar to that of the control circuit 300-2 shown in FIG. 7, except for the mode switching switches 360, 362, 366. Thus, in the power source circuit 30-4, the mode switching switch 360 is always fixed to a terminal “0” side and the mode switching switch 366 is open, thereby providing for separation from the synchronous line 320. Further, the mode switching switch 362 is always fixed to a terminal “0” side, thereby allowing for the actuation by the own oscillator 301.

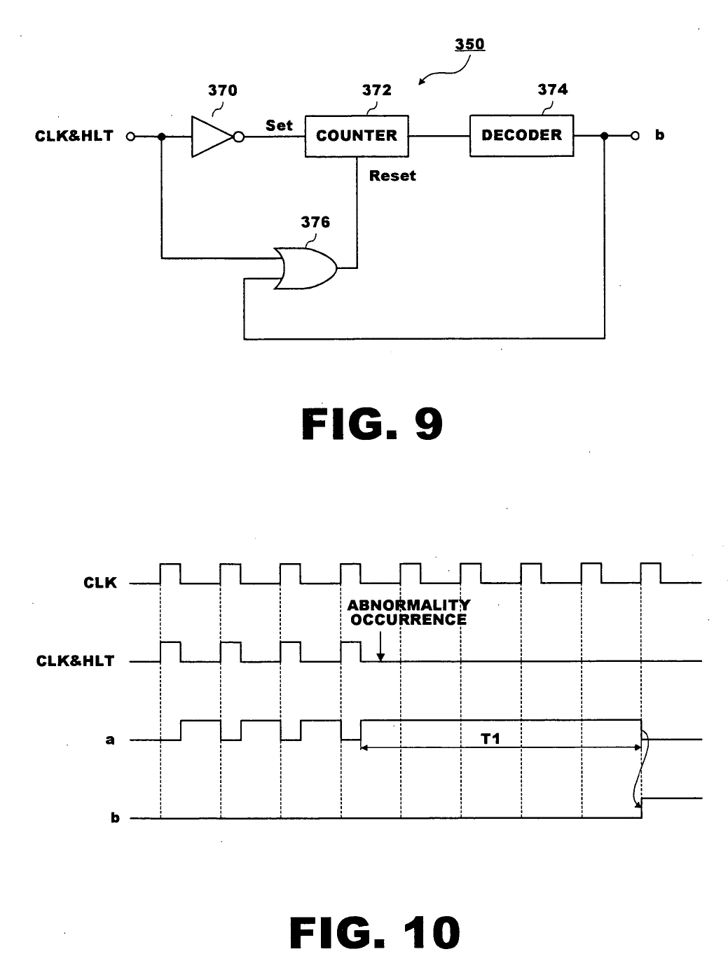

FIG. 9 is a block diagram illustrating a configuration example of the synchronous line monitor shown in FIG. 6, FIG. 7, and FIG. 8. The synchronous line monitor shown in the figure is composed of an inversion element 370, a counter 372, a decoder 374, and an OR element 376. A signal form the synchronization and fault terminal CLK&HLT is inputted in a set terminal of the counter 372 via the inversion element 370 and, at the same time, a signal from the synchronization and fault terminal CLK&HLT is inputted in the reset terminal of the counter 372.

FIG. 10 is a timing chart illustrating the operation of the synchronous line monitor shown in FIG. 9. A signal denoted by “CLK” in the figure shows the state of a clock signal generated by the oscillator 301 of the power source circuit (master) 30-1, a signal denoted by “CLK&HLT” shows the state of a clock signal flowing in the synchronous line 320, a signal denoted by “a” shows a period in which the counter 372 shown in FIG. 9 conducts counting, and a signal denoted by “b” shows the state of a signal outputted by the decoder 37 shown in FIG. 9.

As shown by “CLK” in FIG. 10, the oscillator 301 of the power source circuit (master) 30-1 generates a clock signal of a predetermined frequency, and when the power source circuits connected to the synchronous line 320 are in a normal state, this signal is used as a switching frequency of those power source circuits.

Here, as shown by “CLK&HLT” in the figure, if an abnormality occurs in any of the power source circuits at a certain timing, the switch 360 in the power source circuit where the abnormality has occurred connects the synchronous line 320 to GND and a CLK&HLT signal of the synchronous line 320 is fixed to the GND level.

If the above-described changes are present in the clock signal of the synchronous line 320, then a GND level signal is constantly inputted into the synchronous line monitor 350 provided in each power source circuit. As a result, a set signal is constantly inputted into the counter 372 located in the synchronous line monitor 350 and the counter 372 constantly conducts counting operation (period shown by a Hi level in the figure).

The decoder 374 shown in FIG. 9 compares the values incremented by the counter 372 with a predetermined value T1, thereby calculating the count interval of the counter and outputting a Hi-level signal when this calculated count interval reaches T1. If the decoder 374 outputs the Hi-level signal, the counter 372 is reset via the OR element 376. As a result, each mode switching switch is switched to an abnormal mode via the OR element 354 shown in FIG. 6, FIG. 7, and FIG. 8.

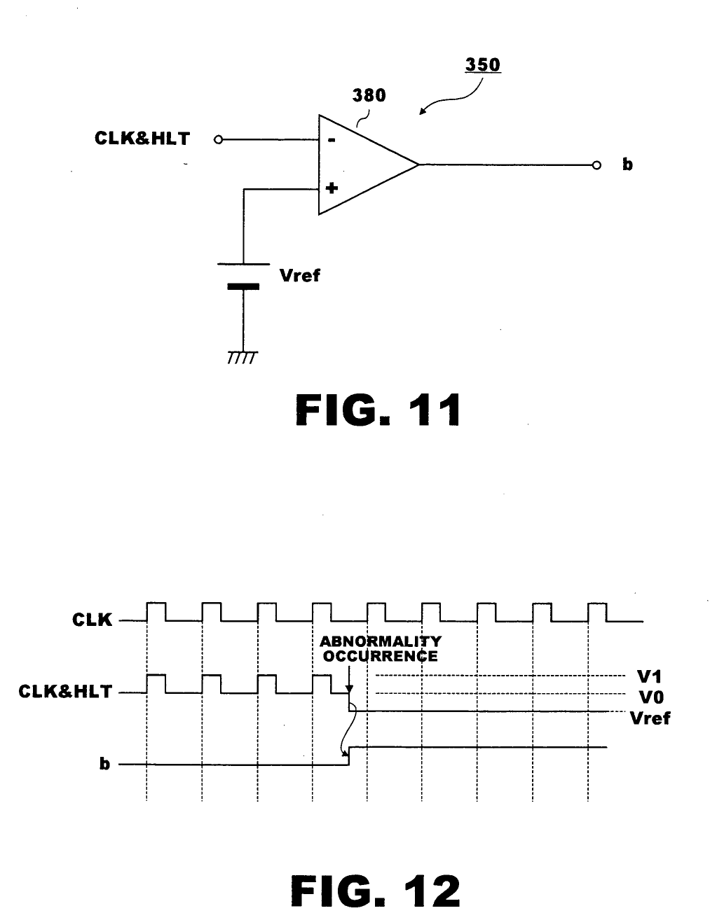

FIG. 11 is a block diagram showing another configuration example of the synchronous line monitor 350 shown in FIG. 6, FIG. 7, and FIG. 8. The synchronous line monitor shown in FIG. 11 is composed of a comparator 380. In this example, a decision is made that an abnormality has occurred when the voltage level of a clock signal from the synchronization and fault terminal CLK&HLT becomes a reference voltage Vref.

FIG. 12 is a timing chart illustrating the operation of the synchronous line monitor shown in FIG. 11. A signal denoted by “CLK” in the figure shows the state of a clock signal generated by the 301 of the power source circuit (master) 30-1, a signal denoted by “CLK&HLT” shows the state of a clock signal flowing in the synchronous line 320, and a signal denoted by “b” shows the state of a signal outputted by the comparator 380 shown in FIG. 11.

As shown by “CLK” in FIG. 12, the oscillator 301 of the power source circuit (master) 30-1 generates a clock signal of a predetermined frequency, and when the power source circuits connected to the synchronous line 320 are in a normal state, this signal is used as a switching frequency of those power source circuits.

Here, as shown by “CLK&HLT” in the figure, if an abnormality occurs in any of the power source circuits at a certain timing, the control circuit in the power source circuit where the abnormality has occurred fixes the voltage level of the synchronous line 320 to Vref. More specifically, a reference voltage having a Vref value may be connected to the synchronous line 320 by using the mode switching switch 360 shown in FIG. 6 and FIG. 7. Further, the Vref value, as shown in FIG. 12, may be less than V1 and V0, may be higher than V0 and V1, or may be a voltage value between V1 and V0.

If the above-described changes are present in the clock signal of the synchronous line 320, then Vref level signal is constantly inputted into the synchronous line monitor 350 provided in each power source circuit. As a result, the comparator 380 of each power source signal outputs a Hi-level signal and each mode switching switch shown in FIG. 6, FIG. 7, and FIG. 8 is switched to an abnormal mode.

The present invention makes it possible to optimize the efficiency for each output voltage and allows for simultaneous shutdown or synchronous oscillation between any output voltages. Therefore, it is expected to be applicable to power source systems requiring control of a higher level

1. A multiple output power source apparatus comprising a plurality of power source circuits equipped with independent output control circuits, wherein
the power source circuits equipped with independent output control circuits respectively comprises:
abnormality signal output means for conducting operation shutdown of own circuit when an abnormality occurs in the own circuit and for outputting an abnormality signal to other power source circuits.

2. The multiple output power source apparatus according to claim 1, wherein the plurality of power source circuits equipped with the independent output control circuits further comprise:
abnormality signal input means for inputting the abnormality signal outputted from other power source circuit; and
operation shutdown means for conducting the operation shutdown of the own circuit by the input of the abnormality signal by the abnormality signal input means.

3. The multiple output power source apparatus according to claim 2, wherein
the abnormality signal output means and the abnormality signal input means conduct input and output of the abnormality signal by using a single terminal.

4. The multiple output power source apparatus according to claim 2, wherein
operation of a power source circuit selected from the plurality of power source circuits equipped with the independent output control circuits is continued by the independent output control circuit even when the abnormality signal has been outputted from the other power source circuits.

5. A multiple output power source apparatus comprising a plurality of power source circuits equipped with independent output control circuits, wherein
the power source circuits equipped with the independent output control circuits respectively comprises:
synchronous oscillation signal output means for outputting a synchronous oscillation signal synchronized with switching oscillation frequency of own circuit to output control circuits of other power source circuits.

6. The multiple output power source apparatus according to claim 5, wherein
the plurality of power source circuits equipped with the independent output control circuits further comprise:
synchronous oscillation signal input means for inputting a synchronous oscillation signal outputted from other power source circuit; and
control means for conducting synchronous control of a switching oscillation frequency used in output control of the own circuit by inputting the synchronous oscillation signal by the synchronous oscillation signal input means.

7. The multiple output power source apparatus according to claim 6, wherein
the synchronous oscillation signal output means and the synchronous oscillation signal input means conduct input and output by using a single terminal.

8. The multiple output power source apparatus according to claim 6, wherein
operation of a power source circuit selected from the plurality of power source circuits equipped with the independent output control circuits is continued by the independent output control circuit even when the abnormality signal has been outputted from the other power source circuits.

9. The multiple output power source apparatus according to claim 6, wherein
the plurality of power source circuits equipped with the independent output control circuits respectively comprises:
control means for synchronously controlling a switching phase used for output control of the own circuit by a switching phase of the synchronous oscillation signal by the synchronous oscillation signal input means.

10. A multiple output power source apparatus comprising a plurality of power source circuits, wherein
at least two of the plurality of power source circuits are connected by a synchronous line,
first and second power source circuits connected by the synchronous line comprise independent control circuits, respectively,
the control circuit provided in the first power source circuit comprises:
synchronous signal output means for outputting a synchronous signal synchronized with the switching frequency of own circuit to the synchronous line; and
abnormality signal output means for outputting an abnormality signal indicating the abnormality occurrence in the own circuit to the synchronous line,
the control circuit provided in the second power source circuit comprises:
synchronous signal input means for inputting the synchronous signal outputted to the synchronous line into the own circuit; and
abnormality signal input means for inputting the abnormality signal outputted to the synchronous line into the own circuit.

11. The multiple output power source apparatus according to claim 10, wherein
the control circuit provided in the first power source circuit further comprises abnormality signal input means for inputting the abnormality signal outputted to the synchronous line into the own circuit,
the control circuit provided in the second power source circuit further comprises abnormality signal output means for outputting the abnormality signal indicating the abnormality occurrence in the own circuit to the synchronous line, and
the first and second power source circuits shut down the own circuits when the abnormality signal has been inputted from the synchronous line.

12. A multiple output power source apparatus comprises a plurality of power source circuits, wherein
at least two of the plurality of power source circuits are connected by a synchronous line,
first and second power source circuits connected by the synchronous line comprise independent control circuits, respectively,
the control circuits provided in the first and second power source circuits respectively comprise:
frequency synchronization means for controlling switching frequency of own circuit by using a synchronous signal outputted to the synchronous line; and
abnormality signal detection means for detecting the abnormality signal outputted to the synchronous line and shutting down the own circuit.

13. The multiple output power source apparatus according to claim 12, wherein
the synchronous signal comprises a clock signal of a predetermined frequency,
the abnormality signal is generated by changing the clock signal, and
the abnormality signal detection means detects change of the clock signal.

14. The multiple output power source apparatus according to claim 13, wherein
the change of the clock signal is generated by the first power source circuit and/or second power source circuit.

15. The multiple output power source apparatus according to claim 13, wherein
the change of the clock signal is implemented by stopping the clock signal, and
the abnormality signal detection means measures an interval during which the clock signal is stopped and shuts down the own circuit when it is detected that the stop state continues for a predetermined interval or longer.

16. The multiple output power source apparatus according to claim 13, wherein
the change of the clock signal is implemented by changing a voltage level of the clock signal, and
the abnormality signal detection means measures the voltage level of the clock signal and shuts down the own circuit when a predetermined voltage level is detected.
